(19) United States
(12) Patent Application Publication
(10) Pub. No.: US 2018/0300492 A1
(43) Pub. Date: Oct. 18, 2018

(54) PRIVACY AND SECURITY IN UICC/eSE LOGGING

(71) Applicant: QUALCOMM Incorporated, San Diego, CA (US)

(72) Inventor: Jeremy Robin Christopher O'DONOGHUE, Wokingham (GB)

(21) Appl. No.: 15/650,840

(22) Filed: Jul. 14, 2017

Related U.S. Application Data
(60) Provisional application No. 62/485,814, filed on Apr. 14, 2017.

(51) Int. Cl. G06F 21/62; G06F 21/30

(52) U.S. Cl. CPC G06F 21/6209; H04L 63/08; G06F 21/6218; G06F 21/30

(57) ABSTRACT

Systems and methods for protecting privacy and security of information transmitted from a Secure Element, such as UICC/eUICC embedded in a processing system, include privacy management units for determining if information transmitted from the Security Element to an external entity comprises data to be masked. If the information comprises data to be masked, gates at endpoints of interfaces between the Secure Element and the external entity are configured with one or more masking rules. The privacy management units may apply the one or more masking rules to selectively mask or omit data before the information is transmitted to the external entity for logging.

### CROSS-REFERENCE TO RELATED APPLICATIONS

The present Application for Patent claims the benefit of U.S. Provisional Patent Application No. 62/485,814, entitled “PRIVACY AND SECURITY IN UICC/eSE LOGGING”, filed Apr. 14, 2017, pending, assigned to the assignee hereof, and hereby expressly incorporated herein by reference in its entirety.

### FIELD OF DISCLOSURE

Disclosed aspects are directed to processing systems. More particularly, exemplary aspects are directed to privacy and security applications in embedded systems on mobile devices.

### BACKGROUND

Standards for Global System for Mobile (GSM) communication are governed by the GSM Association (GSMA). There is an emerging initiative in GSMA to provide standardized logging of communication to/from integrated circuitry such as a Subscriber Identity Module (SIM) card, Universal Integrated Circuit Card (UICC), embedded UICC (eUICC), or the like on mobile devices such as cellular phones.

Existing approaches to providing such standardized logging have some drawbacks.

Firstly, it is difficult to implement standard protocols for capturing logs in the field or during operation of a mobile device, for example. This is because different manufacturers or vendors of chipsets or systems which are integrated on the mobile devices may have different practices which may not lend themselves seamlessly to standardization. Secondly, it can be difficult to implement hardware solutions such as an interposer to monitor and detect information to be logged from the various lines (wires, pins, etc.) which may interface the mobile device and a UICC integrated on the mobile device, for example.

With reference to FIG. 1, system 100 (e.g., pertaining to a mobile device such as a cellular phone) is shown with the main hardware components that support logging of the data coming from UICC/eUICC 122. UICC/eUICC 122 may generate information which needs to be logged on one or both of the two interfaces: International Standards Organization (ISO) interface (e.g., ISO7816) 116 or Single Wire Protocol (SWP) interface 126 between Contactless Frontend (CLF) 118 (sometimes known as a Near Field Communication (NFC) controller) and UICC/eUICC 122. In conventional deployments, commands and responses between Application Processor (AP) 108, which may include a cellular modem, are sent over ISO interface 116. SWP interface 126 between UICC/eUICC 122 and CLF 118 may be used for contactless transactions such as transit ticketing or payments. NFC controller interface (NCI) 114 may be used for communication between CLF 118 and AP 108.

Data to be logged is sent to respective logging filters (logging filter 112 in AP 108, logging filter 120 in CLF 118) which are responsible for filtering out sensitive data before it reaches logging subsystem 110 in AP 108. Logging subsystem 110 then uploads the data over network interface 106, which may be wired or wireless, to remote logging endpoint 102 for further analysis, e.g., in logging analyzer 104.

Conventional approaches related to system 100 have focused on including some directives for logging information in ISO interface 116. Such directives may include configuring a modem integrated on system 100 to generate log packets comprising the content of Application Protocol Data Units (APDUs) transmitted from/to UICC/eUICC 122. However since the APDUs may include private or sensitive information (e.g., secure messaging service (SMS), phonebooks, authentication keys, etc.), such sensitive information may be masked for and hidden from the logged information, particularly for cases wherein UICC/eUICC 122 is in operation but not being tested or placed in a test mode. Log packets containing these APDUs may then be sent to the Application Processor with Downlink Control Information (DCI) present, and converted into a standard format.

Some manufacturers of test equipment have proposed the notion of implementing logging features on SWP interface 126 between CLF 118 and UICC/eUICC 122. This proposal involves enabling logging, by recording all the data bits and their directions (e.g., to/from) between CLF 118 and UICC/eUICC 122. Compared to logging information at ISO interface 116 described above, logging all data bits on a bit level, along with the direction as well as corresponding time stamps per bit would be needed in this approach. One or more specific data lines (e.g., a line of SWP interface 126 known as “C6 SWIO”) may be monitored to obtain the above logging information in this proposal. The proposal further includes configuring CLF 118 to be responsible for collecting the logging data and providing it back to the system, e.g., a Rich Execution Environment (REE) in the case of the Android Operating System (OS) for example. Configuring CLF 118 with such features is with a view to potentially enabling CLF 118 to capture logs (in lieu of, or in addition to, using logging system 110 of AP 108 for this purpose, as discussed above).

However, security and privacy concerns arise from logging data which transits any interface of a secure environment, since there is a high probability that information, including sensitive information that is vulnerable or might potentially be valuable to an attacker, transits these interfaces. The above-described scenario, wherein CLF 118 may send the logging information to a potentially compromised REE for mobile devices in the field, may allow for the attacks to be scalable.

In the case of the previously described approach, wherein ISO interface 116 is utilized for logging, the data transfer and exchange may be under control of the vendor or standardization bodies of UICC/eUICC 122 which may be configured to mask sensitive data. However, in either approaches, the vendor(s) of CLF 118 and UICC/eUICC 122 need not necessarily know about the data which transits SWP interface 126 because logging Applet(s) 124 can be installed on UICC/eUICC 122 after device manufacture to perform the logging. Accordingly, the above-described proposals are fraught with challenges. Therefore there is a recognized need in the art for solutions which allow CLF 118 to mask sensitive information before sending such information to an external REE, e.g., for logging.

Another solution proposed to GSMA is for the logging subsystem to contain software which removes sensitive information based on hard-coded specifications which describe which data elements should be masked. This approach requires that the logging filters 112/120 know, in advance, what data transits the interfaces they monitor, and what information therein is of a sensitive nature. While the GSMA requirements for logging are focused on uses of technology to control security and privacy in logging applications, it may be possible to use similar mechanisms to apply logical filtering of information for all communications between the embedded secure element (eSE), such as UICC/eUICC 122, and external entities. The aforementioned scenarios and use cases may lead to significant enhancements of existing access control mechanisms for secure elements such as those standardized by GlobalPlatform and GSMA.

### SUMMARY

Exemplary aspects of the invention include systems and method directed to privacy and security applications in processing systems. Standardized data masking for logging and other communications from embedded systems such as UICC/eUICC/eSE are implemented using gates at endpoints and one or more masking rules which do not require a priori knowledge of format or contents of data interchanges being logged. Privacy management units may be configured to implement selective masking based on the one or more masking rules of information at interfaces such as SWP and ISO before the information is transmitted to an external entity for logging.

For example, an exemplary aspect is directed to a method of logging information, the method comprising determining if information transmitted from a Security Element comprises data to be masked, the Security Element integrated on a processing system. If the information comprises data to be masked, one or more masking rules are applied to the information before transmitting the information to an external entity for logging.

Another exemplary aspect is directed to an apparatus comprising a Security Element integrated on a processing system and privacy management logic. The privacy management logic is configured to determine if information transmitted from the Security Element comprises data to be masked, and if the information comprises data to be masked, apply one or more masking rules to the information before the information is transmitted to an external entity for logging

Another exemplary aspect is directed to an apparatus comprising means for determining if information transmitted from a Security Element comprises data to be masked, the Security Element integrated on a processing system, and means for applying one or more masking rules to the information before transmitting the information to an external entity for logging if the information comprises data to be masked.

Another exemplary aspect is directed to a non-transitory computer-readable storage medium comprising code, which, when executed by a processor, causes the processor to perform operations for logging information, the non-transitory computer-readable storage medium comprising code for determining if information transmitted from a Security Element comprises data to be masked, the Security Element integrated on a processing system, and code for applying one or more masking rules to the information before transmitting the information to an external entity for logging if the information comprises data to be masked.

### BRIEF DESCRIPTION OF THE DRAWINGS

The accompanying drawings are presented to aid in the description of aspects of the invention and are provided solely for illustration of the aspects and not limitation thereof.

FIG. 1 illustrates aspects of a conventional processing system.

FIG. 2 illustrates an example interchange between an external entity shown and an exemplary embedded system according to exemplary aspects of this disclosure.

FIG. 3 illustrates an exemplary set of rules for data masking implemented in JSON, according to exemplary aspects of this disclosure.

FIG. 4 is a block diagram showing an exemplary communication system in which aspects of the disclosure may be advantageously employed.

FIG. 5 illustrates a method of logging information according to exemplary aspects of this disclosure.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Aspects of this disclosure are directed to logging mechanisms for applications (or logging Applets) residing on a UICC/eUICC (or any other form of Secure Element (SE) or embedded Secure Element (eSE)). The logging Applets may include logging filters and are configured to indicate to external entities how they should mask sensitive information during logging. A significant benefit of exemplary aspects is that the entity collecting the logging does not require detailed knowledge of the protocol used by each of the logging Applets residing in the UICC/eUICC. Further, the rules describing which data needs to be masked can be updated at any time without the need to change the implementation of the logging filters. For example, the rules can be updated by updating the personalization data of the logging Applet in an exemplary UICC/eUICC.

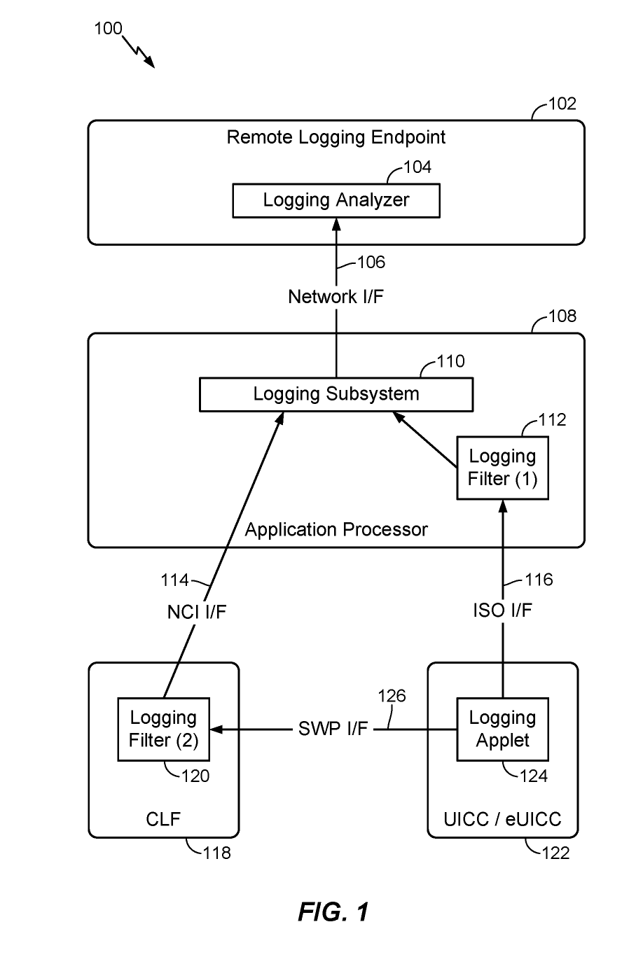

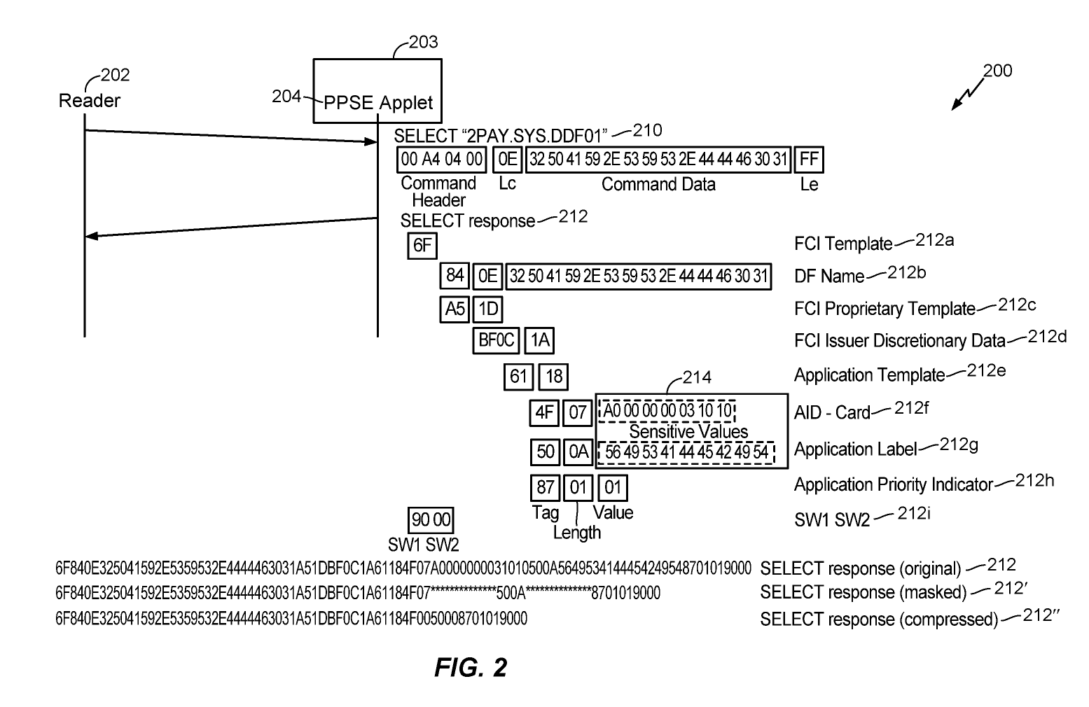

FIG. 2 illustrates an example interchange for a system 200 (e.g., pertaining to a mobile device such as a cellular phone). The interchange is shown for an external entity depicted as reader 202 and an exemplary UICC/eUICC 203. PPSE Applet 204 is more specifically illustrated as part of UICC/eUICC 203 and will be discussed further below. PPSE Applet 204 may be used in contactless payment systems in UICC/eUICC 203. Information transfer to/from UICC/eUICC 203, whether over an ISO interface or over an SWP interface (such as ISO interface 116 or over SWP interface 126 of FIG. 1) may conventionally follow the APDU format, such as specified in the ISO7816-4 standard. Sensitive information may potentially be contained in plaintext form in Command Data fields or Response Data fields of these APDU packets, examples of which will be provided in the following sections.

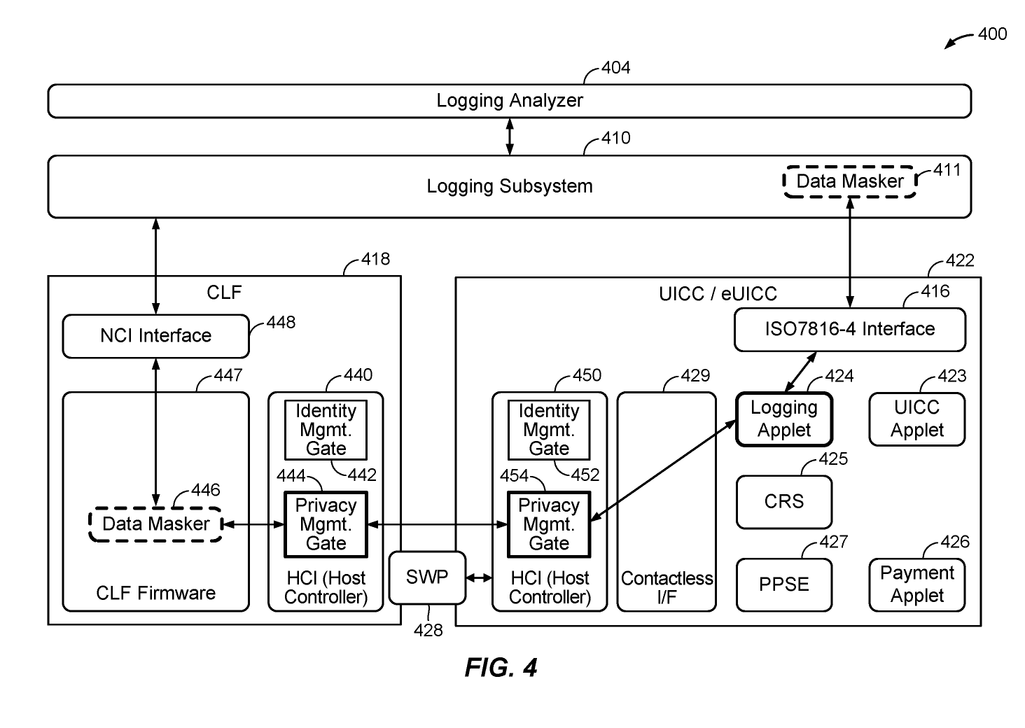

In exemplary aspects, to ensure security of such sensitive information, privacy management logic may be provided, e.g., in UICC/eUICC 203 (examples implementations of the privacy management logic will be discussed with reference to FIG. 4). The privacy management logic may be configured to determine if information transmitted from UICC/eUICC 203 comprises data to be masked, and if the information comprises data to be masked, apply a masking rule to the information before the information is transmitted to the external entity for logging.

In an aspect, the privacy management logic may be configured with the following exemplary functionality for determining which, if any, information is to be masked in system 200. Specifically, the following rules may be implemented for determining if information is to be masked in an exemplary aspect.

(1) If secure messaging is enabled, the data is always masked.

(2) For each Application Identifier (AID) with a Command or Response APDU which has security or privacy requirements, the following simplified rules may be used to determine which data should be masked as follows:
(a) Simple Tag Length Value (TLV) data objects are described as a Tag, Length and Data. If the data field for a particular Simple TLV is sensitive, then a rule specifying that the data field is to be masked for that Tag value is created. In this case the device log omits or masks off the complete TLV.
(b) Basic Encoding Rules (BER) TLV (or BER-TLV) data objects have a more complex structure as they can be “constructed” (which means that there are potentially objects within objects). However the rule description is similar to the preceding: if a specific Tag is sensitive, then a rule specifying that the Tag is to be masked for that Tag value is created. In this case, the device or UICC/eUICC omits the complete TLV including any included constructed TLVs (i.e., all sub-fields of the sensitive Tag).

(3) For files which are sensitive, the path (Master File (MF), Dedicated File (DF) or Elementary File (EF)) is provided as an entry in the rules table containing the data masking rules, and the SELECT operations and other operations on these files are entirely masked.

The above privacy rules may be made available to the external logging entities by means of different mechanisms, e.g., on the SWP and ISO interfaces of an exemplary mobile device or system.

An example implementation of the above rules will now be described for a SELECT operation comprising SELECT command 210 (2PAY.SYS.DDF01) from reader 202 to UICC/eUICC 203 and corresponding SELECT response 212 from UICC/eUICC 203 to reader 202. PPSE Applet 204 is configured to handle the above message exchange in the following manner For an original SELECT response 212, the following fields are shown as being present if no masking is applied: FCI Template 212a, DF Name 212b, FCI Proprietary Template 212c, FCI Issuer Discretionary Data 212d, Application Template 212e, AID-Card 212f, Application Label 212g, Application Priority Indicator 212h, SW1 SW2 212i. These fields include tag length and values as shown within the respective fields 212a-i of SELECT response 212 in FIG. 2.

In an example BER-TLV data object, AID-card 212f and Application Label 212g, the value portions of the respective fields may be considered sensitive, which is collectively depicted as sensitive values 214 in FIG. 2. In an exemplary aspect, sensitive values 214 may be masked in an effort to maintain user security and privacy. PPSE Applet 204 may accordingly mask sensitive values 214 from the AID-card 212f and Application Label 212g fields to generate SELECT response 212′ which is a masked version of the original SELECT response 212. In further aspects, the SELECT response message sent back to reader 202 may be condensed or compressed by excluding the bits related to the masked sensitive values 214 field. An example compressed SELECT response generated in this manner is shown as SELECT response 212″ which is a compressed version of the masked SELECT response 212′.

An example manner in which PPSE Applet 204 may be configured to specify the sensitive values 214 of the above-described TLVs will now be described. PPSE Applet 204 may be configured to implement the following pseudocode algorithm shown for an example application with an Application Identifier (AID) of value 2PAY.SYS.DDF01:
For an application with AID “2PAY.SYS.DDF01” (e.g., pursuant to SELECT command 210)
   For SELECT Response APDU (e.g., SELECT response 212)
      For FCI Issuer Discretionary Data (e.g., field 212d)
         For each Application Template:
         Tag AID-Card is sensitive, (e.g., mask field 214)
         Tag “Application Label” is sensitive (e.g., mask field 214).

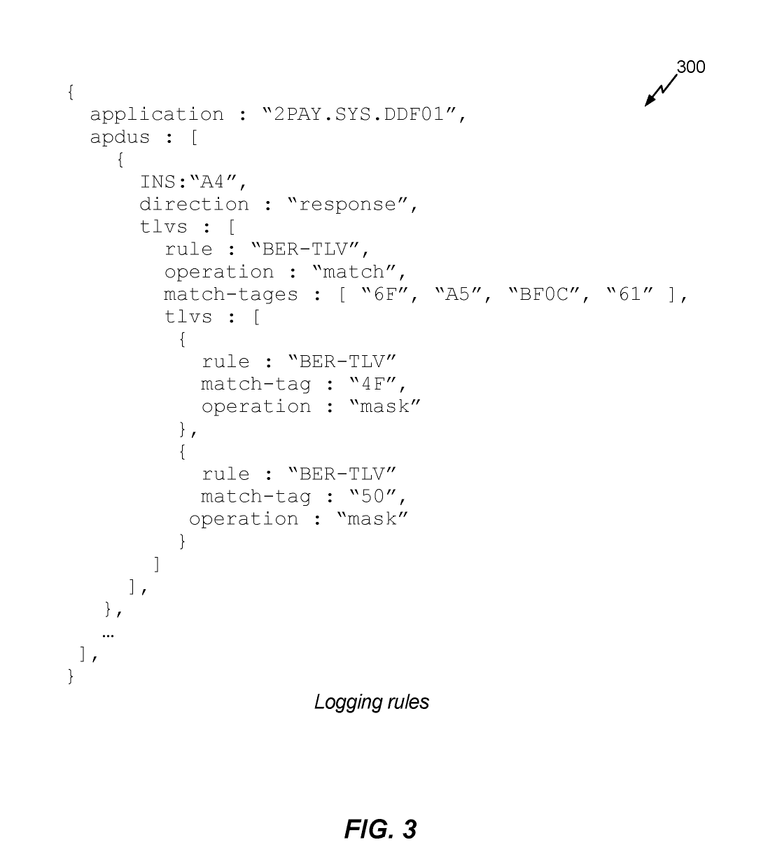

An example description of the above rules in JavaScript Object Notation (JSON) is shown as listing 300 in FIG. 3. It will be appreciated that BER-TLV encodings of the JSON structures in Listing 300, or similar rule implementations, may be realized by one skilled in the art without deviating from the scope of this disclosure.

It will also be recognized that mechanisms within a UICC operating system of system 200, for example, possibly embodied as Applets such as PPSE Applet 204, may allow the Applets to register the rules for sensitive operations which the Applet performs in a rules table or the like. In this way a complete set of the sensitive data exchanges provided by all of the Applets in a device may be obtained, and can be dynamically updated when the UICC Applets are updated or personalized.

With reference now to FIG. 4, system 400 is shown, configured according to exemplary aspects of this disclosure. The following description is provided for exemplary aspects of system 400, while keeping in mind that some components which may be present in system 400 have been shown for the sake of illustration, but have not been exhaustively described given that their function is unchanged compared to implementations familiar to those skilled in the art. Further, the exemplary modifications of some components will be covered in greater detail while omitting the basic functionality of these components which may have been described in FIG. 1. Some example blocks shown in FIG. 4 may be used to mask sensitive information which may be exposed by payment Applet 426 of UICC/eUICC 422, for example.

In system 400, UICC/eUICC 422 and CLF 418 may communicate over SWP interface 428, e.g., a Host Control Interface (HCI) protocol may execute over SWP interface 428 between UICC/eUICC 422 and CLF 418. An exemplary configuration of SWP interface 428 provides for the notion of “gates,” which are defined herein as addressable endpoints located on at least UICC/eUICC 422, and in the implementation shown, also in CLF 418. Further, SWP interface 428 may comprise pipe or channels in communication with the gates. Thus, in an exemplary implementation, SWP interface 428 may have one or more channels in communication with the one or more gates. Masking rules may be stored at the one or more gates and applied at the gates before information is transmitted through the one or more channels from UICC/eUICC 422 to CLF 418, for example. For instance, each gate may contain a registry which defines the masking rules which are associated with the gate. The masking rules may be application specific, and as such, the masking rules for information pertaining to a specific application being transmitted or communicated over SWP interface 428 may be accessed using the Application Identifier (AID) for the application.

CLF 418 may be configured to include Host Controller 440 in an HCI network implementation, while UICC/eUICC 422 may be configured to include Host Controller 450. CLF 418 is shown to comprise NCI interface 448, which is generally configured to facilitate the communication, configuration, and control of functions within CLF 418. CLF Firmware 447 is configured to support the execution of firmware functions within CLF 418.

UICC/eUICC 422 is generally configured to support provisioning of Applets. As discussed herein, Applets are executable programs which perform specific functions. In the example implementation, UICC/eUICC 422 is shown to include Applets such as UICC Applet 423, which provides telephony-related functions; Contactless Registry Service (CRS) 425; Proximity Payment System Environment (PPSE) 427; Payment Applet 426, discussed herein as an exemplary Applet which may potentially generate sensitive data, etc. The above-mentioned Applets may be implemented according to well-known configurations in the art. Aspects of this disclosure also include Logging Applet 424 which will be discussed further in the following sections.

Additionally, UICC/eUICC 422 may also comprise other blocks such as Contactless

Interface 429 configured to enable the above-mentioned Applets executing on the UICC/eUICC 422 to interact with HCI Controller 450, e.g., when configured appropriately. In some examples, CRS 425 may configure the operation of Contactless Interface 429 according to well-known rules in the art.

Host Controller 440 or CLF 418 and each Host Controller 450 such as in UICC/eUICC 422 of system 400 may support respective Identity Management Gates 442 and 452, which contain a list of all of the gates each endpoint supports.

Another exemplary gate is also shown in each endpoint, e.g., Privacy Management Gate 444 in Host Controller 440 and Privacy Management Gate 454 in Host Controller 450. Respective Privacy Management Gate IDs may be associated with or present in any device on the HCI network which supports it, and therefore is included in the GATESLIST registry entry of the Identity Management Gate for that host. Logging Applet 424 in UICC/eUICC 422 may generate the masking rules and transfer it to Privacy Management Gate 454 in Host 450. Accordingly, Privacy Management Gate 454 may comprise privacy management logic configured to determine if information transmitted from UICC/eUICC 422 comprises data to be masked, and if the information comprises data to be masked, apply a masking rule to the information before the information is transmitted to an external entity such as CLF 418 for logging.

In another aspect, Privacy Management Gate 444 of Host Controller 440 in CLF 418 may communicate with Data Masker 446 to implement the masking based on the corresponding masking rules within the CLF 418. Similarly, Logging Applet 424 may also communicate the rules via ISO interface 416 to be implemented by Data Masker 411 in logging subsystem 410 before being forwarded to logging analyzer 404.

In exemplary aspects, The Privacy Management Gate for any Host other than the Host Controller contains a machine-readable list, in a format such as BER-TLV, of the rules used to mask Simple TLV and BER-TLV data, grouped by the AID and APDU INS field to which they apply, using the rules described above (e.g., to generate the masked SELECT response 212′ from SELECT response 212 as described with reference to FIG. 2). The Privacy Management Gate may further contain a list of file system paths for which file operations are blocked from transfer on SWP interface 428. In this manner, exemplary aspects of selectively masking information need not be limited to logging information, but may be extended to any other form of communication or data transfer from UICC/eUICC 422 to external devices (e.g., for enhancing privacy and protection of known protocols such as GlobalPlatform SE Access Control).

With continued reference to FIG. 4, it is noted that ISO interface 416 may not support a service discovery mechanism, and so the above aspects related to SWP Interface 428 may be suitably modified.

In exemplary aspects, an Applet with an AID referred to as “well known” is disclosed, which will enable a connected external entity to recover the privacy rules. In one aspect, the AID may be “L.PRIVACY.SYS”, and data retrieval may correspondingly be performed using the “GET DATA” APDU.

In such a scenario, a connected device may be configured to retrieve the privacy rules by performing the following pseudocode sequence:
SELECT “L.PRIVACY.SYS”
GET DATA

In an aspect, the privacy rules may be encoded in BER-TLV, although alternate implementations such as JSON or Simple TLV are also possible. In a further aspect, the privacy rules may be stored in the ISO7816 filesystem.

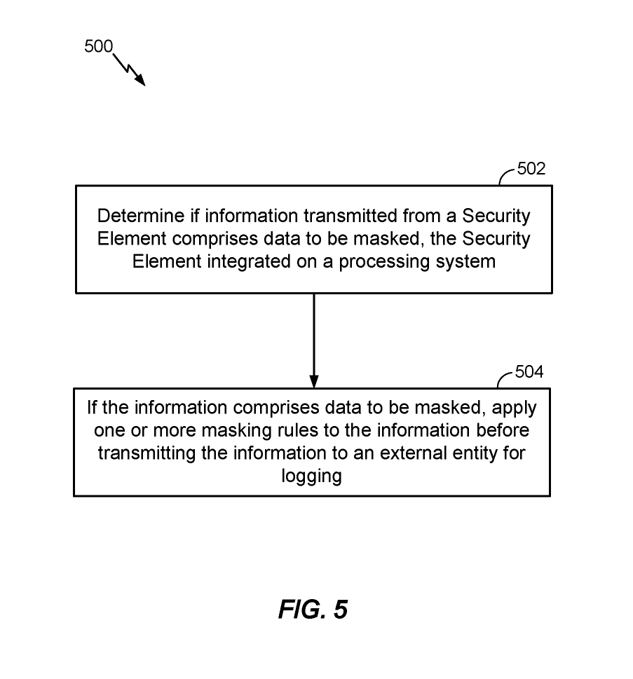

Accordingly, it will be appreciated that aspects include various methods for performing the processes, functions and/or algorithms disclosed herein. For example, as illustrated in FIG. 5, an aspect can include method 500 of logging information (e.g., as discussed with reference to the SELECT operation of FIG. 2 between UICC/eUICC 203 and reader 202).

Block 502 comprises determining if information transmitted from a Security Element (e.g., UICC/eUICC 203) comprises data to be masked, the Security Element integrated on a processing system (e.g., system 200); and

Block 504 comprises, if the information comprises data to be masked, applying one or more masking rules to the information before transmitting the information to an external entity for logging (e.g., masking sensitive field 214 of SELECT response 212 by PPSE Applet 204 on UICC/eUICC 203).

In exemplary aspects of method 500, the Security Element (e.g., UICC/eUICC 422 as shown in FIG. 4) comprises a rules table (e.g., stored at privacy management gate 454) comprising the one or more masking rules, and wherein determining if the information transmitted from the Security Element comprises data to be masked comprises accessing the rules table. Furthermore, determining that the information transmitted from the Security Element comprises data to be masked may be based on if the information is part of a secure message (e.g., PPSE Applet 204 may mask sensitive values 214 from the AID-card 212f and Application Label 212g fields to generate SELECT response 212′ which is a masked version of the original SELECT response 212, as discussed with reference to FIG. 2).

In some aspects, the information transmitted from the Security Element may be determined to comprise data to be masked if the information is part of a command or response Application Protocol Data Unit (APDU) and has a security or privacy requirement (e.g., masking may be applied the SELECT response APDU shown in FIG. 2 as SELECT response 212, if the Tag AID-Card is sensitive or the Tag “Application Label” is sensitive). Applying the one or more masking rules may comprise, if a data field of the command or response APDU expressed as Simple Tag Length Value (TLV) data objects is sensitive, and omitting or masking the data field before transmitting the information to the external entity for logging, and in further detail, applying the one or more masking rules comprises, if a tag field of the command or response APDU expressed as Basic Encoding Rules (BER) Tag Length Value (TLV) data objects is sensitive, and omitting or masking the TLV and any sub fields of the tag field, before transmitting the information to the external entity for logging (e.g., for BER-TLV data objects, if a specific Tag is sensitive, then UICC/eUICC omits the complete TLV including any included constructed TLVs).

If the information transmitted from the Security Element comprises a file in a sensitive path, then applying the one or more masking rules comprises omitting the file before transmitting the information to the external entity for logging (e.g., the path (Master File (MF), Dedicated File (DF) or Elementary File (EF)) may be provided as an entry in the rules table containing the one or more masking rules, and the SELECT operations as shown in FIG. 2 on these files may be entirely masked).

Referring to FIG. 4, method 500 may involve communicating between the Security Element and the external entity over a Single Wire Protocol (SWP) interface (e.g., SWP interface 428 between UICC/eUICC 422 and CLF 418), wherein at least the Security Element comprises one or more gates (e.g., privacy management gate 454) and the SWP interface comprises one or more channels in communication with the one or more gates, and wherein the one or more masking rules are stored at the one or more gates, wherein transmitting the information from the Security Element to the external entity comprises applying the one or more masking rules at the gates before the information is transmitted through the one or more channels. For instance, as noted above, when the information to be transmitted pertains to an application, accessing the one or more masking rules may be based on an Application Identifier (AID) for the application. Further, an external entity such as CLF 418 may also comprise one or more gates (e.g., privacy management gate 444) in communication with the one or more channels related to SWP 428, for example.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The foregoing disclosed devices and methods are typically designed and are configured into GDSII and GERBER computer files, stored on a computer-readable media. These files are in turn provided to fabrication handlers who fabricate devices based on these files. The resulting products are semiconductor wafers that are then cut into semiconductor die and packaged into a semiconductor chip. The chips are then employed in devices described above.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of logging information, the method comprising:
determining if information transmitted from a Security Element comprises data to be masked, the Security Element integrated on a processing system; and
if the information comprises data to be masked, applying one or more masking rules to the information before transmitting the information to an external entity for logging.

2. The method of claim 1, wherein the Security Element is a Universal Integrated Circuit Card (UICC) or an embedded UICC (eUICC).

3. The method of claim 1, wherein the Security Element comprises a rules table comprising the one or more masking rules, and wherein determining if the information transmitted from the Security Element comprises data to be masked comprises accessing the rules table.

4. The method of claim 1, comprising determining that the information transmitted from the Security Element comprises data to be masked if the information is part of a secure message.

5. The method of claim 1, comprising determining that the information transmitted from the Security Element comprises data to be masked if the information is part of a command or response Application Protocol Data Unit (APDU) and has a security or privacy requirement.

6. The method of claim 5, wherein applying the one or more masking rules comprises, if a data field of the command or response APDU expressed as Simple Tag Length Value (TLV) data objects is sensitive, and omitting or masking the data field before transmitting the information to the external entity for logging.

7. The method of claim 5, wherein applying the one or more masking rules comprises, if a tag field of the command or response APDU expressed as Basic Encoding Rules (BER) Tag Length Value (TLV) data objects is sensitive, and omitting or masking the TLV and any sub fields of the tag field, before transmitting the information to the external entity for logging.

8. The method of claim 1, comprising determining that the information transmitted from the Security Element comprises a file in a sensitive path, and wherein applying the one or more masking rules comprises omitting the file before transmitting the information to the external entity for logging.

9. The method of claim 1, comprising communicating between the Security Element and the external entity over a Single Wire Protocol (SWP) interface, wherein at least the Security Element comprises one or more gates and the SWP interface comprises one or more channels in communication with the one or more gates, and wherein the one or more masking rules are stored at the one or more gates.

10. The method of claim 9, wherein transmitting the information from the Security Element to the external entity comprises applying the one or more masking rules at the one or more gates before the information is transmitted through the one or more channels.

11. The method of claim 10, wherein the information pertains to an application, and wherein accessing the one or more masking rules is based on an Application Identifier (AID) for the application.

12. The method of claim 10, wherein the external entity comprises a Contactless Frontend (CLF), and wherein the CLF further comprises one or more gates in communication with the one or more channels.

13. An apparatus comprising:
a Security Element integrated on a processing system; and
privacy management logic configured to determine if information transmitted from the Security Element comprises data to be masked, and if the information comprises data to be masked, apply one or more masking rules to the information before the information is transmitted to an external entity for logging.

14. The apparatus of claim 13, wherein the Security Element is a Universal Integrated Circuit Card (UICC) or an embedded UICC (eUICC).

15. The apparatus of claim 13, wherein the Security Element comprises a rules table comprising the one or more masking rules, and wherein the privacy management logic is configured to access the rules table to determine if the information transmitted from the Security Element comprises data to be masked.

16. The apparatus of claim 13, wherein the privacy management logic is configured to determine that the information transmitted from the Security Element comprises data to be masked if the information is part of a secure message.

17. The apparatus of claim 13, wherein the privacy management logic is configured to determine that the information transmitted from the Security Element comprises data to be masked if the information is part of a command or response Application Protocol Data Unit (APDU) and has a security or privacy requirement.

18. The apparatus of claim 17, wherein the one or more masking rule compris, if a data field of the command or response APDU expressed as Simple Tag Length Value (TLV) data objects is sensitive, and then the data field is omitted or masked before the information is transmitted to the external entity for logging.

19. The apparatus of claim 17, wherein applying the one or more masking rule comprises, if a tag field of the command or response APDU expressed as Basic Encoding Rules (BER) Tag Length Value (TLV) data objects is sensitive, then the TLV and any sub fields of the tag field are omitted or masked before the information is transmitted to the external entity for logging.

20. The apparatus of claim 13, wherein the one or more masking rule comprise, if the information transmitted from the Security Element comprises a file in a sensitive path, then the file is omitted before the information is transmitted to the external entity for logging.

21. The apparatus of claim 13, comprising a Single Wire Protocol (SWP) interface configured for communication between the Security Element and the external entity over, wherein at least the Security Element comprises one or more gates and the SWP interface comprises one or more channels in communication with the one or more gates, and wherein the one or more masking rules are stored at the one or more gates.

22. The apparatus of claim 21, wherein the one or more masking rules are applied at the one or more gates before the information is transmitted through the one or more channels.

23. The apparatus of claim 22, wherein the information pertains to an application, and wherein the one or more masking rules are accessed based on an Application Identifier (AID) for the application.

24. The apparatus of claim 22, wherein the external entity comprises a Contactless Frontend (CLF), and wherein the CLF further comprises one or more gates in communication with the one or more channels.

25. An apparatus comprising:
means for determining if information transmitted from a Security Element comprises data to be masked, the Security Element integrated on a processing system; and
means for applying one or more masking rules to the information before transmitting the information to an external entity for logging if the information comprises data to be masked.

26. The apparatus of claim 25, further comprising means for communicating between the Security Element and the external entity over a Single Wire Protocol (SWP) interface, wherein at least the Security Element comprises one or more means for storing the one or more masking rules.

27. The apparatus of claim 26, wherein the information pertains to an application, and means for accessing the one or more masking rules based on an Application Identifier (AID) for the application.

28. A non-transitory computer-readable storage medium comprising code, which, when executed by a processor, causes the processor to perform operations for logging information, the non-transitory computer-readable storage medium comprising:
code for determining if information transmitted from a Security Element comprises data to be masked, the Security Element integrated on a processing system; and
code for applying one or more masking rules to the information before transmitting the information to an external entity for logging if the information comprises data to be masked.

29. The non-transitory computer-readable storage medium of claim 28, further comprising code for communicating between the Security Element and the external entity over a Single Wire Protocol (SWP) interface, wherein at least the Security Element comprises one or more means for storing the one or more masking rules.

30. The non-transitory computer-readable storage medium of claim 29, wherein the information pertains to an application, and code for accessing the one or more masking rules based on an Application Identifier (AID) for the application.
